(19) United States
(12) Patent Application Publication
(10) Pub. No.: US 2006/0179476 A1
(43) Pub. Date: Aug. 10, 2006

(54) Data security regulatory rule compliance

(75) Inventors: David Carroll Challener, Raleigh, NC (US); Richard W. Cheston, Morrisville, NC (US); Daryl Carvis Cromer, Apex, NC (US); Howard Jeffrey Locker, Cary, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 11/054,391

(22) Filed: Feb. 9, 2005

(51) Int. Cl. H04L 9/32

(52) U.S. Cl. 726/4

(57) ABSTRACT

A method and system is presented for making a client computer compliant with a data security regulatory rule. A client computer is connected to a network that includes a compliance fix server. The compliance fix server determines if the client computer is in compliance with a data security regulatory rule, based on a level of compliance at which that the client computer is authorized. If the client computer has not executed the appropriate compliance software required to put the client computer in compliance with the data security regulatory rule, then the compliance fix server sends appropriate compliance software to the client computer for installation and execution.

### BACKGROUND OF THE INVENTION

1. Technical Field

This invention relates generally to network computing systems, and in particular to remotely managed computers. Still more particularly, the present invention relates to a method and system for dynamically bringing a computer into compliance with one or more data security regulatory rules.

2. Description of the Related Art

While early computers were “stand alone” and unable to communicate with other computers, most computers today are able to communicate with other computers for a variety of purposes, including sharing data, e-mailing, downloading programs, coordinating operations, etc. This communication is achieved by logging onto a Local Area Network (LAN) or a Wide Area Network (WAN).

To address the issue of different computers connecting to the network and concurrently running different operating systems, virtual machines and virtual machine monitors were developed. Virtual Machine Monitors (VMMs) have been the subject of research since the late 1960's. A VMM, also called a “hypervisor,” is a thin piece of software that runs directly on top of hardware, and virtualized all of the hardware resources of the machine. Since the VMM's interface is the same as the hardware interface of the machine, an operating system cannot determine the presence of the VMM. Consequently, when the hardware interface is one-for-one compatible with the underlying hardware, the same operating system can run either on top of the VMM or on-top of the raw hardware. It is then possible to run multiple instances of operating systems or merely instances of operating system kernels if only a small subset of system resources is needed. Each instance is referred to as a “virtual machine.” The operating system can be replicated across virtual machines or distinctively different operating systems can be used for each virtual machine. In any case, the virtual machines are entirely autonomous and depend on the VMM for access to the hardware resources such as hardware interrupts.

While this expanded horizon of using networks, with or without the use of VMMs, has obvious benefits, it comes at the cost of increased exposure to mischief, including unauthorized usage.

Unauthorized usage was initially just an internal policy problem. That is, certain employees were authorized by their employer to access particular databases while other employees were not. This authorization could be based on the employee's title, department, job description, or any other parameter set by the employer. Today, however, authorized usage may also be determined by data security regulatory rules. A data security regulatory rule is defined herein as a governmental or non-governmental non-technical rule for prohibiting unauthorized access to specified data. As defined, the data security regulatory rule may be promulgated by a governmental body such as the United States federal government, or from a non-governmental organization such as the International Organization for Standardization (ISO). The data security regulatory rule is “non-technical” in that it does not define or describe computer, network, software or other technical protocols for accessing data. Rather, the data security regulatory rule describes guidelines for non-technical protocols and/or administrative steps that are required to be taken to ensure that only authorized access to a database, particularly on a network, occurs.

An exemplary data security regulatory rule is a rule required by the Health Insurance Portability and Accountability Act (HIPAA) requiring computers to append the following signature section in outgoing email:

“This communication may contain information that is legally protected from unauthorized disclosure. If you are not the intended recipient, please note that any dissemination, distribution, or copying of this communication is strictly prohibited. If you have received this message in error, you should notify the sender immediately by telephone or by return email and delete this message from your computer.”

If this signature section is not part of the outgoing email, then that computer may not send out HIPAA protected data, and doing so places the sender and the sender's enterprise in violation of HIPAA.

It is currently very difficult for enterprises to determine if all of the client computers on a network are in compliance with data security regulatory rules, particularly since compliance requirements may vary per department. For example, HIPAA may allow a medical records department to have access to a patient's medical history, but prohibit such information from being accessed by a billing department. Thus, the message described above may be required in the medical records department, but not required (or even authorized) in the billing department.

### SUMMARY OF THE INVENTION

What is needed, therefore, is a method and system that ensure that a client computer on a network is in compliance, at an appropriate level, with a data security regulatory rule. Preferably, if the client computer is out of compliance, then a dedicated compliance server automatically provides software code to the client computer that puts the client computer into compliance.

As will be seen, the present invention satisfies the foregoing needs and accomplishes additional objectives. Briefly described, the present invention provides a method and system for ensuring that a client computer is compliant with a data security regulatory rule.

A client computer is connected to a network that contains a compliance fix server. The compliance fix server determines if the client computer is in compliance with a data security regulatory rule, based on a level of compliance at which that the client computer is authorized. If the client computer has not executed the appropriate compliance software required to put the client computer in compliance with the data security regulatory rule, then the compliance fix server sends appropriate compliance software to the client computer for installation and execution.

### BRIEF DESCRIPTION OF THE DRAWINGS

The novel features believed characteristic of the invention are set forth in the appended claims. The invention itself, however, as well as the preferred modes of use, further objects and advantages thereof, will best be understood by reference to the following detailed description of an illustrative embodiment when read in conjunction with the accompanying drawings, wherein:

FIG. 1 depicts a schematic diagram illustrating a computer network within which the present invention may be used;

FIG. 2 illustrates an exemplary client computer that needs compliance software;

FIG. 3 depicts an exemplary compliance fix server that supplies the compliance software to the client computer;

FIG. 4a is a flow-chart of steps taken to download the compliance software using a primary operating system (OS) to reconfigure a Network Interface Card (NIC) driver, such that the NIC only communicates with the compliance fix server, when the client computer is initially turned off;

FIG. 4b is a flow-chart of steps taken to download the compliance software using the primary OS to reconfigure the NIC driver when the client computer is initially turned on;

FIG. 5a is a flow-chart of steps taken to download the compliance software using a Virtual Machine (VM) and Virtual Machine Monitor (VMM) to reconfigure the NIC driver when the client computer is initially turned off;

FIG. 5b is a flow-chart of steps taken to download the compliance software using the VM and VMM to reconfigure the NIC driver when the client computer is initially turned on;

FIG. 6 is a system virtualization layer diagram showing the abstraction layers in a client running virtualization software which includes a Virtual Machine Monitor (VMM); and

FIG. 7 is a block diagram of an embodiment in which various functions of FIGS. 4a-6 are performed in hardware.

### DETAILED DESCRIPTION OF THE PREFERRED EMBODIMENT

While the present invention will be described more fully hereinafter with reference to the accompanying drawings, in which a preferred embodiment of the present invention is shown, it is understood at the outset of the description which follows that persons of skill in the appropriate arts may modify the invention herein described while still achieving the favorable results of this invention. Accordingly, the description which follows is to be understood as being a broad, teaching disclosure directed to persons of skill in the appropriate arts, and not as limiting upon the present invention.

Referring now to the drawing figures, in which like numerals indicate like elements or steps throughout the several views, a preferred embodiment of the present invention will be described. In general, the present invention provides an improved method and system for determining the authorization and need for compliance software in a client computer, and downloading needed compliance software from a compliance fix server to the client computer. Compliance software is defined as software required to place a computer in compliance with a data security regulatory rule. Similarly, a compliance fix is defined as a portion, either a part or whole, of the compliance software that is needed to bring the computer into compliance with the data security regulatory rule. As described in greater detail above, a data security regulatory rule is defined as a governmental or non-governmental non-technical rule for prohibiting unauthorized access to specified data.

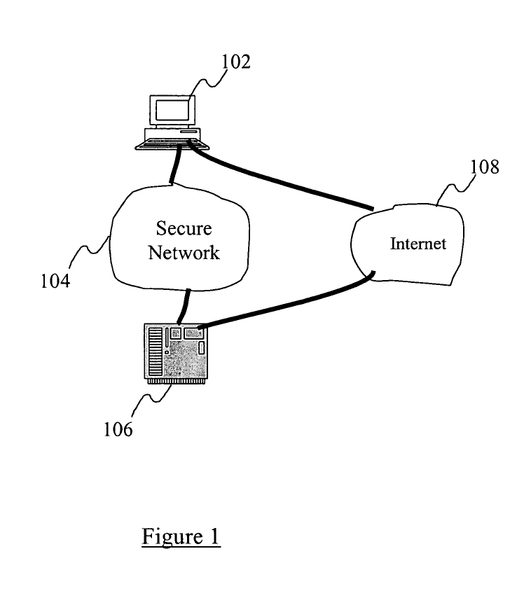

With reference now to FIG. 1, there is depicted an exemplary diagram of a client computer 102 coupled to a secure network 104, which is coupled to a compliance fix server 106. In an alternate embodiment, communication between client computer 102 and compliance fix server 106 may be via an insecure network, such as the Internet 108. In another alternate embodiment, client computer 102 and compliance fix server 106 can securely be connected together using a Virtual Private Network (VPN) through Internet 108.

Compliance fix server 106 is capable of delivering (downloading) software required to bring client computer 102 into compliance with a specific data security regulatory rule, according to the level of authorization held by a specific client computer 102. Additional details of client computer 102 and compliance fix server 106 are given below.

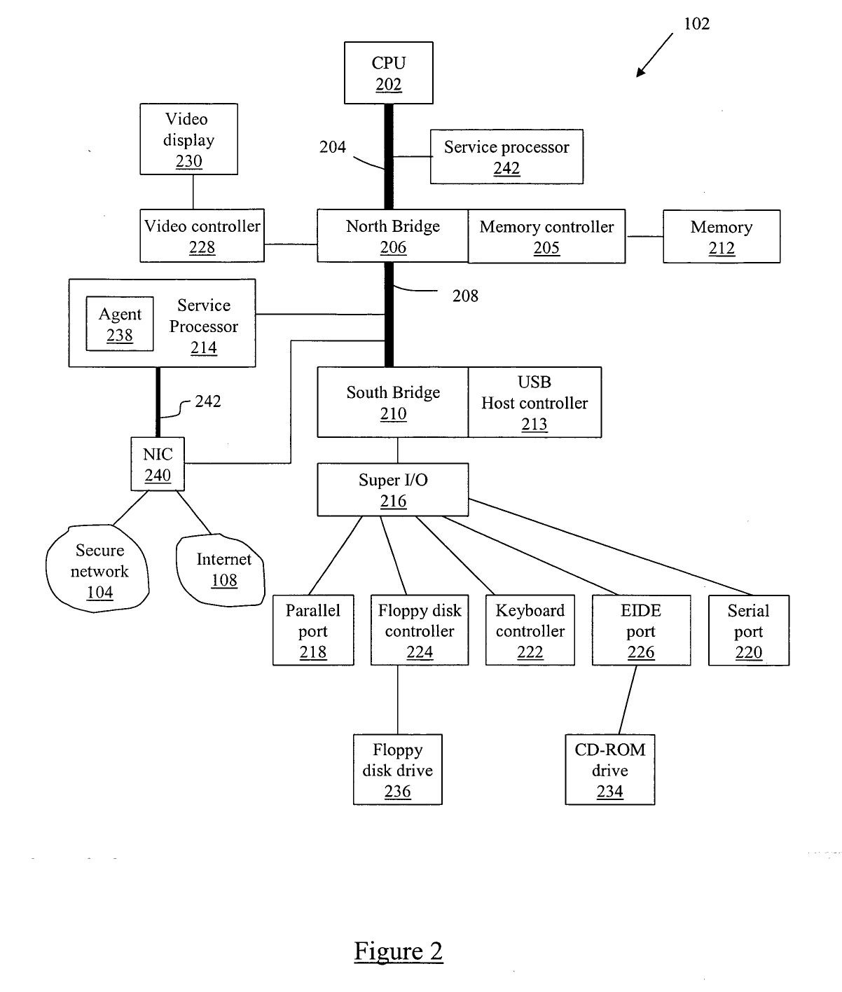

With reference now to FIG. 2, additional detail of client computer 102 is given. A Central Processing Unit (CPU) 202 connects via a processor interface bus 204 (also referred to in the art as a “front side bus,” “host bus,” or “system bus”) to a North Bridge 206. North Bridge 206 is a chip or chipset arbiter logic circuit having a memory controller 207 connected to a system memory 212. A video controller 228 is coupled to North Bridge 206 and a video display 230 for viewing a graphical user interface of software operations being performed on client computer 102 by remote compliance fix server 106. Also connected to North Bridge 206 is a high speed interconnect bus 208. North Bridge 206 is connected via interconnect bus 208, which may be a Peripheral Component Interconnect (PCI) bus, to a South Bridge 210.

South Bridge 210 is a chip or chipset Input/Output (I/O) arbiter that includes the necessary interface logic to convey signals from interconnect bus 208 to (typically slower) I/O interfaces, including a Super I/O 216. Super I/O 216 is preferably a chip or chipset including necessary logic and interfaces for a parallel port 218 and a non-USB (Universal Serial Bus) serial port 220, as are understood in the art of computer architecture. Super I/O 216 may also include controllers for non-USB devices such as a keyboard controller 222 for a non-USB keyboard and an Enhanced Integrated Device Electronics (EIDE) port 226, to which is connected to one or more Compact Disk-Read Only Memory (CD-ROM) drives 234. Also connected to Super I/O 216 is a floppy disk controller 224. Floppy disk controller 224 supports an interface with one or more floppy disk drives 236.

Coupled with South Bridge 210 is a USB host controller 213, which provides a USB interface from USB compliant devices (not shown) to client computer 102, including CPU 202. USB compliant devices may be floppy disk drives, CD-ROM drives, keyboards and other peripheral devices that are configured to comply with the “Universal Serial Bus Specification” release 2.0, Apr. 27, 2000 (USB.org), which release or later is herein incorporated by reference in its entirety. USB host controller 213, which is likewise USB compliant, may be implemented in a combination of hardware, firmware and/or software.

Communication between client computer 102 and outside networks, such as secure network 104 or non-secure Internet 108, is via a Network Interface Card (NIC) 240, which is connected to South Bridge 210 via interconnect (PCI) bus 208. Alternatively, NIC 240 is connected via a system management bus 242 to a Service Processor (SP) 214, which is connected to interconnect bus 208. SP 214 is a specialized hardware processor that can be used to configure NIC drivers for NIC 240, as described in greater detail below.

Within SP 214 is an agent 238. Agent 238 is a software program that performs a variety of tasks related to downloading compliance software, as described in further detail. While agent 238 is depicted as being integral with SP 214, agent 238 may alternately be stored in memory 212 or any other storage area accessible to client computer 102, particularly if client computer 102 does not have an SP 214. As will be described, agent 238 can also be implemented entirely in hardware or partially in hardware and partially in software. Additionally, agent 238, as described in further detail, can run as a part of a Virtual Machine Monitor (VMM). Agent 238, in its many forms, is also known as an Antidote Agent, or as an Antidote.

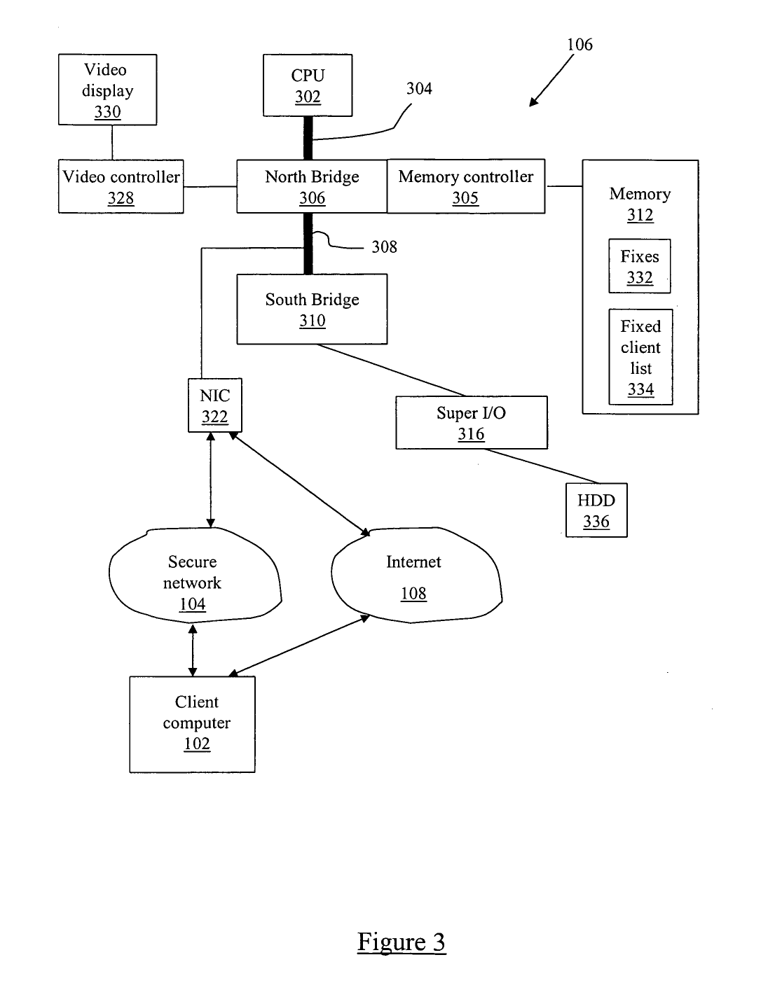

With reference now to FIG. 3, there is depicted a block diagram of an exemplary compliance fix server 106. A Central Processing Unit (CPU) 302 connects via a processor interface bus 304 (also referred to in the art as a “front side bus,” “host bus,” or “system bus”) to a North Bridge 306. North Bridge 306 has a memory controller 307 connected to a system memory 312. Stored within system memory 312 are fixes 332, which may be any type of software fixes, including compliance software programs, program “patches,” program updates, etc. Also stored within system memory 312 is a fixed (i.e., “repaired,” “updated,” etc.) client list 334, which contains a listing of all client computers under compliance fix server's 106 authority that have (or have not) received a fix stored and listed in fixes 332. Alternatively, compliance fix server 106 may broadcast an offer to receive and execute a fix to all client computers on a network, thereby ensuring higher client coverage. Note that information, including listed fixes 332, may be stored on a secondary storage device, such as but not limited to a Hard Disk Drive (HDD) 336, which can be read by executing a program in CPU 302 to read the required information and perform the requisite execution as described herein.

Also connected to North Bridge 306 is a high speed interconnect bus 308. Also connected to North Bridge 306 is a video controller 328, which drives a video display 330.

North Bridge 306 is connected via interconnect bus 308, which may be a Peripheral Component Interconnect (PCI) bus, to a South Bridge 310. South Bridge 310 includes the necessary interface logic to convey signals from interconnect bus 308 to a Super I/O 316. Connected to Super I/O 316 may be the types of peripherals described above with regard to Super I/O 216 in FIG. 2. Connected to interconnect bus 308 is a Network Interface Card (NIC) 322, which provides an interface, via either secure network 104 or the Internet 108, with client computer 102.

Note that the exemplary embodiments shown in FIGS. 2 and 3 are provided solely for the purposes of explaining the invention and those skilled in the art will recognize that numerous variations are possible, both in form and function. All such variations are believed to be within the spirit and scope of the present invention.

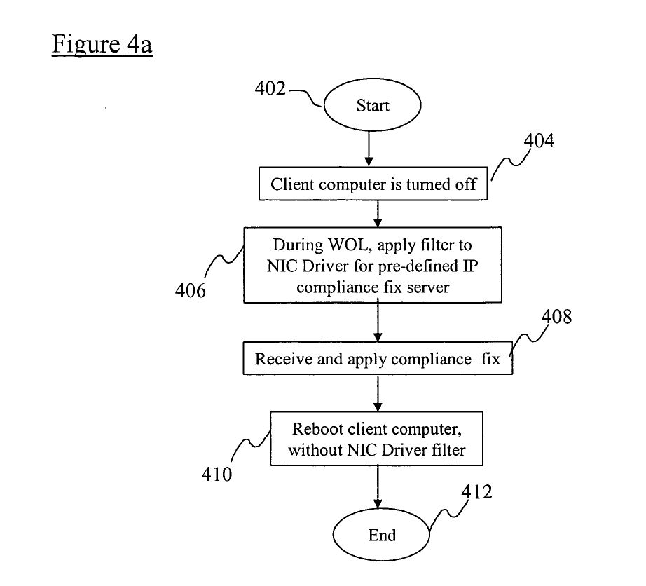

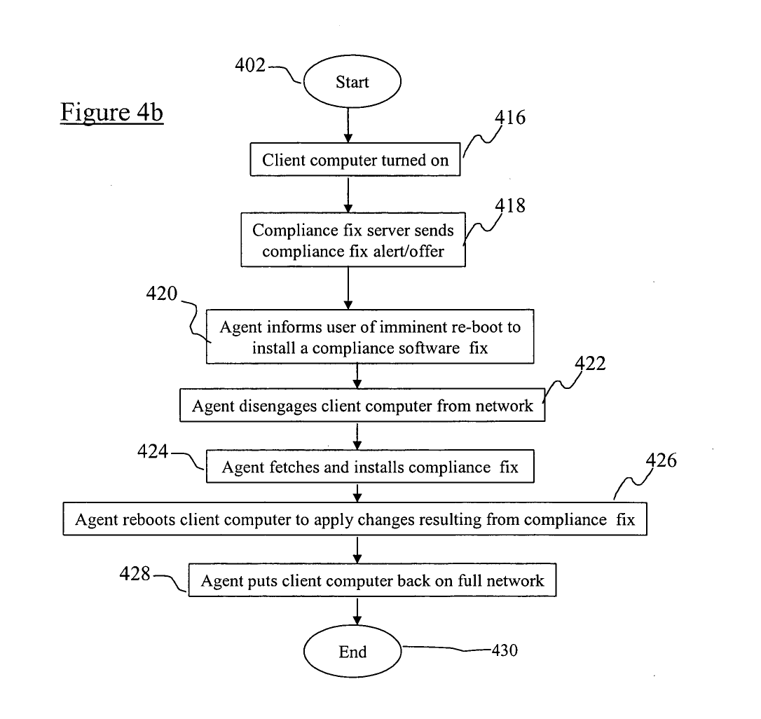

Referring now to FIG. 4a, there is illustrated a flow-chart describing steps taken to download a compliance fix. A compliance fix is defined herein as software needed by client computer 102 to bring client computer 102 into compliance with a specific rule or rules defined in a governmental or non-governmental non-technical compliance act. For exemplary purposes only, note that the compliance fix may be a partial portion of the compliance software defined above, or the compliance fix may be an entire compliance software program. As described above, the data security regulatory nile is “non-technical” in that it does not define or describe computer, network, software or other technical protocols for accessing data. Rather, the data security regulatory rule describes guidelines for administrative steps that are to be taken to ensure that unauthorized access to a database, particularly on a network, does not occur. Examples of such compliance acts include the Health Insurance Portability and Accountability Act (HIPAA), the Gramm-Leach-Bliley Act (GLBA), and the ISO 17799 Standard.

HIPAA is described in the U.S. Federal Registry, Volume 63, No. 155/Wednesday, Aug. 12, 1998/Proposed Rules, pages 43269 to 43271, which is herein incorporated by reference in its entirety. HIPAA describes required security levels for data access control, virus checking, removal of records, data authentication, encryption, et al. as related to patient health care records.

GLBA, codified at 15 USC § 6801-6810, and herein incorporated by reference in its entirety, regulates the disclosure of customer/client financial information by financial institutions, such as banks, insurance companies, stock brokers, etc.

The ISO 17799 Standard, promulgated by the International Organization of Standardization (ISO), and herein incorporated by reference in its entirety, is a voluntary compliance standard that defines rules for security policy, organizational security, asset classification and control, personnel security, physical and environmental security, communications and operations management, access control, systems development and maintenance, business continuity management and legal compliance, all related to enterprise information systems.

With reference again to FIG. 4, and now proceeding from initiator step 402, a condition is assumed that the client computer is initially turned off (step 404). The compliance fix server then wakes up the client computer, preferably using a Wake On LAN (WOL) protocol, in which a “magic packet” (message which includes sixteen sequential iterations of the client computer's Media Access Control-MAC address) received at the client computer's NIC wakes up the client computer from a reduced power state. The compliance fix server has checked the fixed client list, and “knows” that the client computer has not received the compliance software. Alternatively, the compliance fix server does not care if the contacted client computer has received the fix, and simply broadcasts the offer for the fix to any client on the network. Such a broadcast preferably uses a User Datagram Protocol (UDP) formatted datagram, thus providing a checksum to verify that the fix offer has been transmitted intact.

In the preferred embodiment, during the WOL operation the magic packet includes instructions to the client computer to apply a filter to the NIC drivers allowing the NIC to communicate only with the pre-authorized compliance fix server (step 406). The client computer then fully wakes up, and receives and applies (installs and runs) the compliance software (step 408). The client computer is then rebooted without the NIC driver filter, allowing the client computer 410 to communicate with any other resource on the network (block 410), and the process is ended (terminator block 412).

FIG. 4b depicts steps taken that are similar to those described in FIG. 4a, except that the client computer is initially turned on (blocks 414 and 416). The compliance fix server sends an compliance software alert to client computer (block 418). An agent stored in the client computer informs the user of the client computer that an imminent re-boot is about to occur, in order to force the downloading of a compliance software fix (block 420). The agent then disengages the client computer from the network (block 422), permitting the NIC to communicate with only the compliance fix server, as described above in FIG. 4a. The agent fetches the compliance software (fix) from the compliance fix server and installs it (block 424). The agent then re-boots the client computer, applying the changes prompted by the compliance software fix (block 426), and the client computer is put back on line with the entire network (blocks 428 and 430).

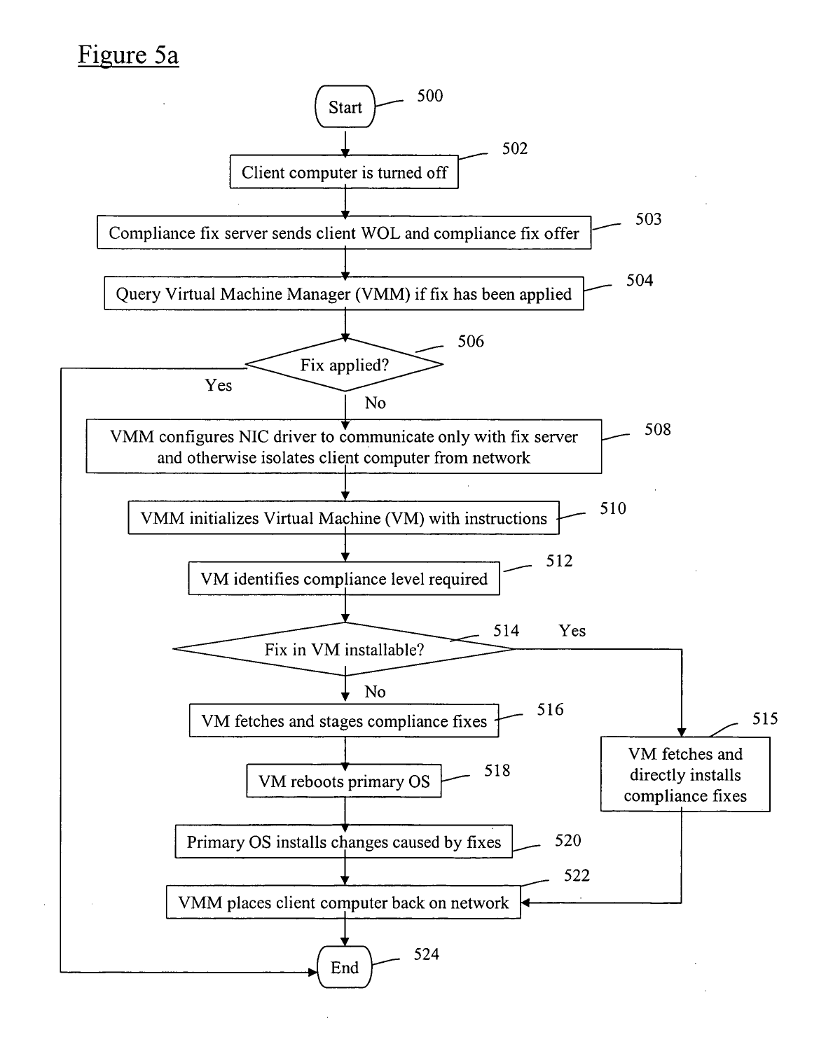

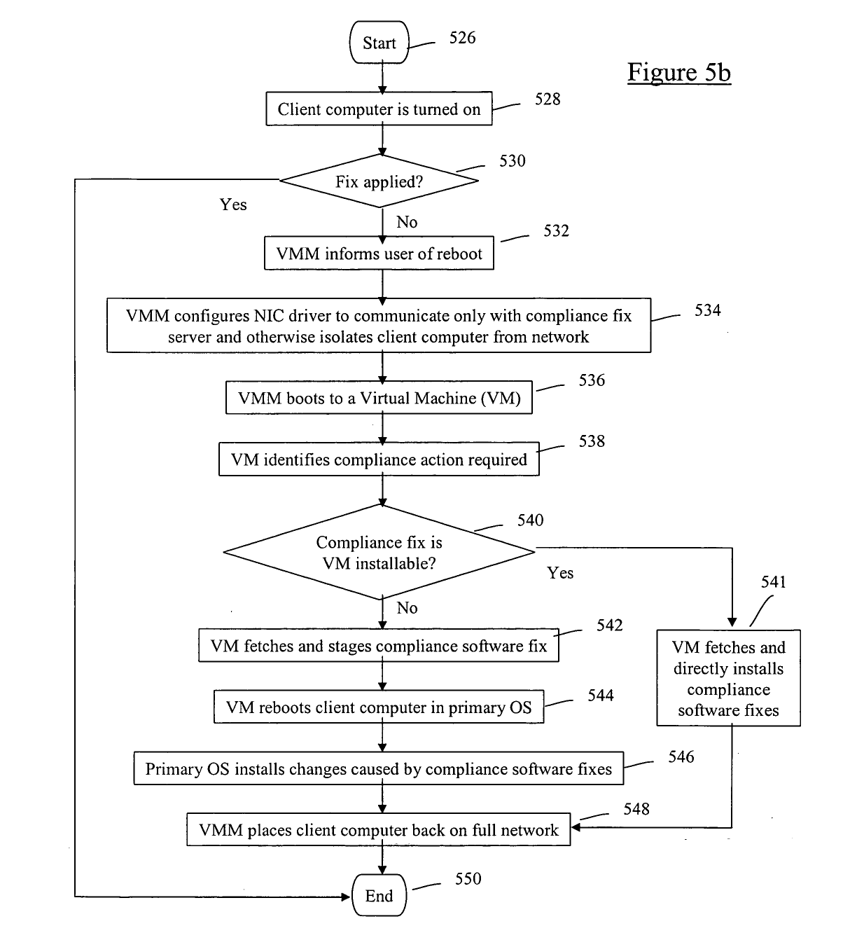

An embodiment of the present invention with an even higher level of security can be implemented by utilizing a Virtual Machine Monitor (VMM) and associated “virtual machine,” as referred to above. This can be implemented by modifying the VMM according t the example given below with reference to FIGS. 5a and 5b. These modifications can be applied to currently available virtualization software executed by CPU 202 out of memory 212, such as the ESX Server software product from VMware Corporation. Additionally, for a higher level of security, support for virtualization can be built into any or all of CPU 202, North Bridge 206, and Memory Controller 207. For example, any of these components can be modified to physically block inter-memory access for different virtual machines, contain redundant hardware for virtualization purposes, and provide specialized access including encrypted access to hardware resources. Moreover, it is well known in the art that software components can be readily implemented as hardware and visa-versa. Accordingly, alternative embodiments can include portions of the VMM itself, which can be implemented in any or all of CPU 202, North Bridge 206, and Memory Controller 207.

Refening now to FIG. 5a, assume that the client computer is initially turned off (block 500 and 502). The compliance fix server sends a packet including a fix (compliance software) as well as a Wake-On-LAN (WOL) signal to the client computer. A VMM, rather than the SP 214 of FIG. 2, can perform the functions described relative to agent 238 in the client computer to query software and memory in client computer 102 to see if the client computer has already installed the sent compliance software (block 504). If now (query block 506), the VMM then resets the NIC drivers to communicate only with the compliance fix server and otherwise completely isolates the client computer from the network (block 508). That is, the VMM performs the NIC driver setting operation that was performed by the OS's described in FIGS. 4 and 5, but with the use of the VMM and the main processor. Moreover, any of the known methods of network isolation (block 508) can be used including application of a filter or mask to any level of communication code ranging from the driver level all the way to the UDP or TCP/IP level or higher. The VMM then initiates a virtual machine (VM) with instructions pre-stored in the VMM (block 510), and identifies compliance software actions required by the instructions according to an authorized compliance level of the client computer (block 512). As an alternative to initiating a VM, the VMM can perpetually maintain an active VM just for this purpose and transfer control to the VM when corrective action is required.

If the fixes are installable by the VM (or alternatively by the VMM) directly (decision block 514), then the VM fetches and directly installs the compliance software fixes (block 515), and the client computer is put back on full line on the network by the VMM (block 522 and 524). Otherwise, the VM fetches and stages the compliance software fixes (block 516), and reboots the primary OS (block 518). The primary OS installs the changes caused by the compliance software (block 520), and the client computer is put back on full line on the network by the VMM (blocks 522 and 524). When fully on line on the network, the client computer is now authorized to access data regulated by a data security regulatory rule (at that client computer's authorization level).

FIG. 5b addresses a similar condition as addressed in FIG. 5a, but the client computer is initially running (blocks 526 and 528). If the VMM determines that the compliance software being offered by the compliance fix server has not been previously downloaded (query block 530), then the VMM informs the user of the client computer that a forced re-boot is imminent (block 532). The VMM then resets the NIC drivers to communicate only with the compliance fix server and otherwise completely isolates the client computer from the network (block 534), and the VMM invokes a VM or transfers control to a perpetual VM as described above.

The VM identifies what compliance software fix action is required (block 538). If the fixes are directly installable by the VM (or by the VMM) (decision block 540), the VM fetches and directly installs the compliance software fixes (block 541), and the client computer is put back on full line n the network by the VMM (blocks 548 and 550). Otherwise, the VM fetches and stages the compliance fix software (block 542), and then re-boots in the primary OS (block 544). The primary OS installs the changes caused by the compliance software (block 546), and the VMM puts the client computer back on the full network (blocks 548 and 550).

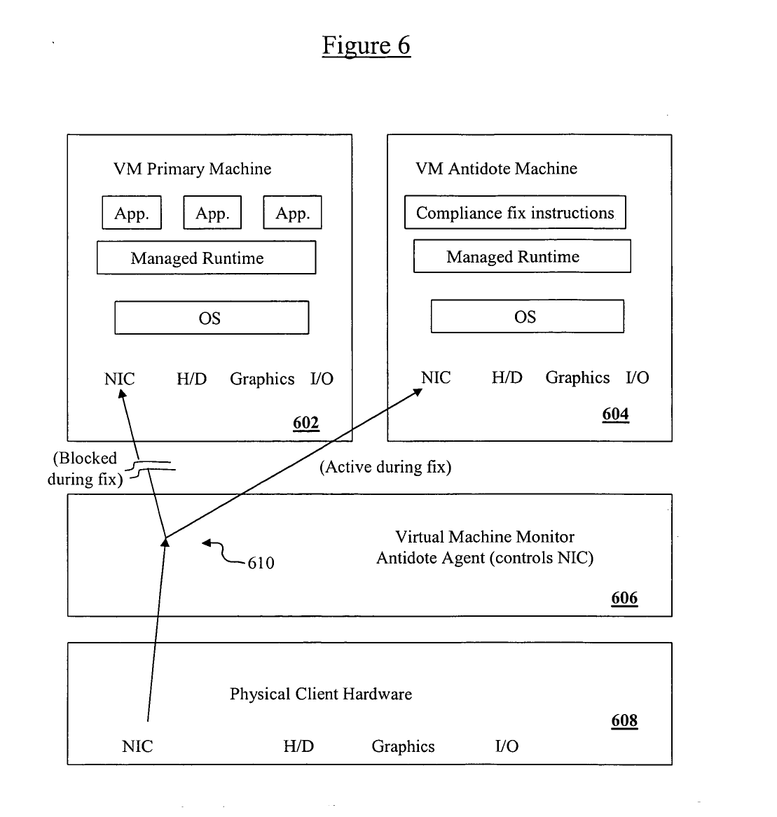

FIG. 6 is a system virtualization layer diagram showing the abstraction layers in a client running virtualization software which includes a Virtual Machine Monitor (VMM). At the lowest level of abstraction is the hardware layer 608; this is the physical hardware layer of the client machine. A Virtual Machine Monitor layer 606 is an intermediary layer which sits on top of the hardware layer 808 and intercepts all access attempts to the physical hardware by software running on the client machine. It is within the Virtual Machine Monitor layer 606 that the Antidote Agent 238 runs and is executed as part of the Virtual Machine Monitor, and as such, has all the security and isolation features of the Virtual Machine Monitor. At the highest level of abstraction lie the virtual machines 602 and 604, which ultimately run operating systems and software applications. Virtual machines can be configured so as to know not of the existence of other virtual machines; they can be isolated and autonomous as would be the case for virtual machine 604 which executes the compliance software instructions provided by and under the control of the Antidote Agent 238 from the Virtual Machine Monitor layer 606. Arrows 610 indicate the isolation of the NIC to virtual machine 602 during a compliance software fix operation while allowing VM Antidote machine 604 to communicate only with the compliance fix server as described above relative to FIGS. 5a and 5b.

Using the VM Antidote Machine 604 under the control of the Antidote Agent running as part of the Virtual Machine Monitor in layer 606 allows for the control and monitoring of all communications present in the client computer, including Modem, WAN, WLAN, Serial Port, USB and other ports. This embodiment is both immune from attack and utilizes the primary CPU 202 and the entire client computer for fix/patch management if desired.

In a preferred embodiment, client computer 102 monitors, using any known system monitoring software and/or hardware, whether client computer 102 can configure the NIC 240 as described above using a primary OS, a secondary OS, or a Service Processor, such as SP 214, or a Virtual Machine Monitor. That is, if the client computer 102 has a Virtual Machine Manager (VMM), then the first choice is to use the VMM to run the Antidote Agent in a manner described in FIGS. 5a-6. If the client computer has an SP 214, then the second choice is to use SP 214 to configure NIC 240 in a manner described in FIGS. 5a-6.

Embodiments of the present invention include various functions, which have been described above with reference to FIGS. 4a-6. The functions may be performed by hardware components or may be embodied in machine-executable instructions, which may be used to cause a general-purpose or special-purpose processor programmed with the instructions to perform the functions. Alternatively, the functions may be performed by a combination of hardware and software.

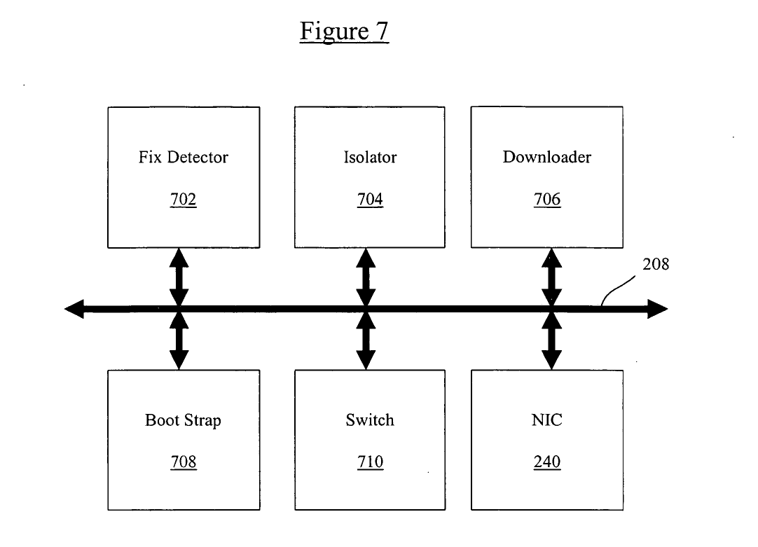

FIG. 7 is a block diagram of an embodiment in which various functions of FIGS. 4a-6 are performed in hardware. Fix detector 702, Isolator 704, Downloader 706, Boot Strap 708, Switch 710, and NIC 240 (shown in FIG. 2) are all coupled to the high speed interconnect (PCI) bus 208. Fix detector 702 discerns an offer for a software fix from a compliance fix server as described with respect to any of the previously described embodiments. Isolator 704 is responsible for controlling and isolating NIC 240 such that communication can only occur with the compliance fix server upon a receipt of the offered software fix. Isolator 704 can perform the isolation function according to any of the embodiments previously described. Downloader 706 functions to effect the transfer of the software fix from the compliance fix server to the client computer according to any of the above described embodiments. Boot strap 708 reboots the client computer according to any previous embodiment after the software fix has been downloaded and executed. Isolator 704 reconnects the client computer to the network without restrictions after the software fix is loaded and executed. Switch 710 selects the best method according to availability of a primary OS, a secondary OS, a Service Processor (such as SP 214), or a Virtual Machine Manager (VMM) as described above.

An embodiment of the present invention may be provided as a computer program product which may include a machine-readable medium having stored thereon instructions which may be used to program a computer (or other electronic device) to perform a process according to any of the embodiments of the present invention. The machine-readable medium may include, but is not limited to, floppy diskettes, optical disks, CD-ROMs, magneto-optical disks, ROMs, RAMs, EPROMs, EEPROMs, magnet or optical cards, or other types of media that are of a machine-readable media suitable for storing electronic instructions. Moreover, an embodiment of the present invention may also be downloaded as a computer program product, wherein the program may be transferred from a remote computer to a requesting computer by way of data signals embedded in a carrier wave or other propagation medium via a communication link (e.g., a modem or network connection).

Note that, in an alternate embodiment of the present invention, the compliance software (fix) provided to the client computer from the compliance fix server may be dependent on a level of compliance required in the client computer. For example, HIPAA may require a medical records department to have certain features in their Information Technology (IT) system (such as data access controls or disclaimer notices), while a billing department may have different required features under HIPAA. Thus, each department can be thought of as a “club” in which each client computer has a same compliance requirement. Before sending the compliance software fix, the compliance fix server may first determine which “club” the client computer belongs, and then send only the compliance fix required for that level of compliance. If a client computer is in an appropriate “club,” but is not in compliance with a requisite data regulatory rule, then that client computer will receive the necessary compliance fix. Alternatively, if that client computer is not in the “club,” then no compliance fix will be sent to that client computer.

The present invention thus provides a method for a client computer to have either full or restricted access to resources on a network. In a restricted access mode, the client computer can still perform certain operations and access certain resources (such as accessing patient billing records) but not other resources (such as patient medical chart records).

In alternate preferred embodiments, the processes described herein for downloading compliance fixes may be as a result of a security policy scan, such as but not limited to a Workstation Security Tool (WST) scan, in response to a regulated mailbox being opened, in response to compliance tagged data being prevented from entering into or egressing from a non-compliant client computer, in response to an elapsing of a predetermined length of time and/or in response to the client computer logging onto a network (including sending a request to a Dynamic Host Configuration Protocol-DHCP server). Thus, such a scan may be a list of all security and/or compliance items and policies that are installed on the client computer. If the scan indicates that the requisite compliance software (programs/policies) has been installed, then access to data that is regulated by a compliance rule is allowed. However, if the scan indicates that some or all of the requisite programs/policies have not been installed, then the appropriate fixes may be installed, depending on the security (compliance) level of the client computer.

The present invention has been described in relation to particular embodiments that are intended in all respects to be illustrative rather than restrictive. Although specific terms are used, the description thus given uses terminology in a generic and descriptive sense only and not for purposes of limitation, unless otherwise noted. Alternative embodiments will become apparent to those skilled in the art to which the present invention pertains without departing from its spirit and scope. Accordingly, the scope of the present invention is defined by the appended claims rather than the foregoing discussion.

What is claimed is:

1. A method comprising:
determining if a client computer on a network is compliant with a data security regulatory rile; and
in response to determining that the client computer is not in compliance with the data security regulatory rule, limiting the client computer's access to data on the network.

2. The method of claim 1, further comprising:
in response to determining that the client computer is not in compliance with the data security regulatory rule, determining what level of compliance the client computer is authorized to be in with regards to the data security regulatory rule; and
in response to determining the level of compliance that the client computer is authorized to be in, sending to the client computer a compliance fix that permits the client computer to have access to the network at a level commiserate with the level of compliance at which the client computer is authorized.

3. The method of claim 2, wherein the compliance fix is sent from a compliance fix server that is dedicated to serving compliance fixes.

4. The method of claim 1, wherein the data security regulatory rule is promulgated by a governmental compliance act.

5. The method of claim 4, wherein the governmental compliance act is the Health Insurance Portability and Accountability Act (HIPAA).

6. The method of claim 1, further comprising:
scanning the client computer to determine what requisite compliance software has been loaded on the client computer, wherein the requisite compliance software is software that is required by the data security regulatory rule to permit access to data that is regulated according to the data security regulatory rule; and
in response to the scanning determining that at least a portion of the requisite compliance software has not been installed on the client computer, downloading the at least a portion of the requisite compliance software from a compliance fix server to the client computer.

7. The method of claim 1, wherein the data security regulatory rule is promulgated by the International Organization for Standardization (ISO).

8. A computer program product, residing on a computer usable medium, comprising:
program code for determining if a client computer on a network is compliant with a data security regulatory rule; and
program code for, in response to determining that the client computer is not in compliance with the data security regulatory rule, limiting the client computer's access to the network.

9. The computer program product of claim 8, further comprising:
program code for, in response to determining that the client computer is not in compliance with the data security regulatory rule, determining what level of compliance the client computer is authorized to be in with regards to the data security regulatory rule; and
program code for, in response to determining the level of compliance the client computer is authorized to be in, sending to the client computer a compliance fix that permits the client computer to have access to the network at a level commiserate with the level of compliance at which the client computer is authorized.

10. The computer program product of claim 9, wherein the compliance fix is sent from a compliance fix server that is dedicated to serving compliance fixes.

11. The computer program product of claim 8, wherein the data security regulatory rule is promulgated by a governmental compliance act.

12. The computer program product of claim 11, wherein the governmental compliance act is the Health Insurance Portability and Accountability Act (HIPAA).

13. The computer program product of claim 11, further comprising:
computer program code for scanning the client computer to determine what requisite compliance software has been loaded on the client computer, wherein the requisite compliance software is software that is required by the data security regulatory rule to permit access to data that is regulated according to the data security regulatory rule; and
computer program code for, in response to the scanning determining that at least a portion of the requisite compliance software has not been installed on the client computer, downloading the at least a portion of the requisite compliance software from a compliance fix server to the client computer.

14. The computer program product of claim 8, wherein the data security regulatory rule is promulgated by the International Organization for Standardization (ISO).

15. A system comprising:
a compliance fix server that is capable of determining if a client computer on a network is compliant with a data security regulatory rule, and in response to determining that the client computer is not in compliance with the data security regulatory rule, limiting the client computer's access to the network.

16. The system of claim 15, wherein the compliance fix server is further capable of:
in response to determining that the client computer is not in compliance with the data security regulatory rule, determining what level of compliance the client computer is authorized to be in with regards to the data security regulatory rule; and
in response to determining the level of compliance the client computer is authorized to be in, sending to the client computer a compliance fix that permits the client computer to have access to the network at a level commiserate with the level of compliance at which the client computer is authorized.

17. The system of claim 16, wherein the compliance fix server is dedicated to serving compliance fixes.

18. The system of claim 15, wherein the data security regulatory rule is promulgated by a governmental compliance act.

19. The system of claim 18, wherein the governmental compliance act is the Health Insurance Portability and Accountability Act (HIPAA).

20. The system of claim 18, wherein the data security regulatory rule is promulgated by the International Organization for Standardization (ISO).
